(19) United States
(12) Patent Application Publication
(10) Pub. No.: US 2024/0100506 A1
(43) Pub. Date: Mar. 28, 2024

(54) PROCESS FOR PRODUCING SUPERABSORBENT PARTICLES

(71) Applicant: BASF SE, Ludwigshafen (DE)

(72) Inventors: Ruediger Funk, Ludwigshafen (DE); Matthias Weismantel, Ludwigshafen (DE); Marcus Maemecke, Ludwigshafen (DE)

(21) Appl. No.: 18/266,861

(22) PCT Filed: Dec. 7, 2021
(86) PCT No.: PCT/EP2021/084567

§ 371 Date: Jun. 13, 2023

(30) Foreign Application Priority Data
Dec. 16, 2020 (EP) 20214556.1

(51) Int. Cl. B01J 20/30; B01J 20/26; C08F 6/00; C08J 3/00; C08J 3/075; C08J 3/16; C08J 3/24

(52) U.S. Cl. CPC B01J 20/3085; B01J 20/267; C08F 6/008; C08J 3/005; C08J 3/075; C08J 3/16; C08J 3/245; B01J 2220/68; C08J 2333/02

(57) ABSTRACT

A process for producing thermally surface postcrosslinked superabsorbent particles, comprising polymerization of a monomer solution or suspension, static drying of the resultant aqueous polymer gel, comminution of the dried polymer gel, classification of the resultant polymer particles, with removal of excessively small polymer particles as undersize, mixing of the removed undersize with an aqueous solution, said aqueous solution comprising a crosslinker, and recycling of the polymer gel obtained from the undersize into the static drying.

The present invention relates to a process for producing thermally surface postcrosslinked superabsorbent particles, comprising polymerization of a monomer solution or suspension, static drying of the resultant aqueous polymer gel, comminution of the dried polymer gel, classification of the resultant polymer particles, with removal of excessively small polymer particles as undersize, mixing of the removed undersize with an aqueous solution, said aqueous solution comprising a crosslinker, and recycling of the polymer gel obtained from the undersize into the static drying.

Superabsorbents are used to produce diapers, tampons, sanitary napkins and other hygiene articles, but also as water-retaining agents in market gardening. Superabsorbents are also referred to as water-absorbing polymers.

The production of superabsorbents is described in the monograph “Modern Superabsorbent Polymer Technology”, F. L. Buchholz and A. T. Graham, Wiley-VCH, 1998, pages 71 to 103.

To improve the performance properties, for example gel bed permeability (GBP) and absorption under a pressure of 49.2 g/cm² (AUL0.7 psi), superabsorbent particles are generally surface postcrosslinked. This increases the level of crosslinking of the particle surface, which can at least partly decouple the absorption under a pressure of 49.2 g/cm² (AUL0.7 psi) and the centrifuge retention capacity (CRC). This surface postcrosslinking can be performed in the aqueous gel phase. Preferably, however, polymer particles (base polymer), having been dried, ground and sieved off, are surface coated with a surface postcrosslinker and thermally surface postcrosslinked. Crosslinkers suitable for that purpose are compounds which can form covalent bonds with at least two carboxylate groups of the polymer particles.

EP 0 789 047 A1 describes a process for producing superabsorbents, wherein polymer particles are agglomerated with an aqueous solution and the aqueous solution comprises a crosslinker.

WO 2019/221235 A1 and WO 2019/221236 A1 describe processes for producing superabsorbent particles, wherein polymer particles are agglomerated with water, and the resultant polymer gel is recycled.

It was an object of the present invention to provide an improved process for producing superabsorbent particles, especially for production of superabsorbent particles with a high absorption rate.

The object was achieved by a process for producing superabsorbent particles by polymerizing a monomer solution or suspension comprising
a) at least one ethylenically unsaturated monomer which bears acid groups and is at least partly neutralized,
b) at least one crosslinker 1 and
c) at least one initiator,
   comprising the steps of
i) polymerizing the monomer solution or suspension and optionally extruding the resultant polymer gel 1,
ii) drying the polymer gel,
iii) comminuting the dried polymer gel,
iv) classifying the polymer particles obtained in step iii), with removal of excessively small polymer particles as undersize 1 and optionally with recycling of excessively large particles into step iii), and with thermal surface postcrosslinking of the remaining polymer particles in a further step,
v) mixing the removed undersize with an aqueous solution and optionally extruding the resultant polymer gel 2 and
vi) recycling polymer gel 2 into step ii),
   wherein the polymer gel is statically dried in step ii), the moisture content of the polymer gel 2 obtained in step v) is from 20% to 80% by weight, the aqueous solution in step v) comprises at least one crosslinker 2, and the crosslinker 2 can form covalent or ionic bonds with at least two carboxylate groups of the polymer particles.

The present invention is based on the finding that agglomerates produced from removed undersize increase the absorption rate. What is important here is that agglomeration is effected in the presence of a crosslinker, and that the polymer gel 2 thus obtained is dried together with the remaining polymer gel, without mixing the two polymer gels.

If the polymer gels are mixed, for example extruded together, the crosslinker will be distributed uniformly over the entire polymer gel and the concentration of crosslinker in polymer gel 2 will be lowered. This leads to less stable agglomerates. At the same time, the polymer gel 1 is additionally crosslinked. This leads to a lower absorption capacity.

In a preferred embodiment of the present invention, the removed undersize in step v) is first mixed with water and optionally extruded and then mixed with the aqueous solution and optionally extruded. This results in preswelling of the removed undersize before the actual addition of crosslinker 2.

If the removed undersize is preswollen with water before the addition of the aqueous solution, preferably at least 50% by weight, more preferably at least 70% by weight, most preferably at least 90% by weight, of the total amount of water added in step v) is used for preswelling. The total amount of water added in step v) here is the amount of water added and the water content of the aqueous solution added.

The effect of this preswelling of the undersize is that the crosslinker applied with the aqueous solution penetrates less deep into the undersize. This leads to better crosslinking between the undersize particles and hence to agglomerates that are more stable in the wet state.

In a further preferred embodiment of the present invention, the removed undersize in step v) is first mixed with an aqueous base and optionally extruded and then mixed with the aqueous solution and optionally extruded. This results in pretreatment of the removed undersize before the actual addition of crosslinker 2.

If the removed undersize is pretreated with an aqueous base before the addition of the aqueous solution, preferably from 0.1% to 12% by weight of base is used, based on the undersize. Suitable bases are sodium hydroxide, sodium carbonate and sodium hydrogencarbonate. For example, a 50% by weight sodium hydroxide solution may be used as aqueous base.

The effect of the pretreatment of the undersize is that crosslinking sites in the undersize are hydrolyzed and the centrifuge retention capacity (CRC) of the undersize is increased.

The temperature in step v) is preferably from 20 to 90° C., more preferably from 25 to 75° C., most preferably from 30 to 60° C.

The aqueous solution in step v) preferably comprises from 0.01% to 1.0% by weight, more preferably from 0.02% to 0.5% by weight, most preferably from 0.05% to 0.2% by weight, of crosslinker 2, based in each case on the amount of underside removed.

Suitable crosslinkers 2 usable in step v) are compounds that can form covalent bonds with at least two carboxylate groups of the polymer particles, for example ethylene carbonate and ethylene glycol diglycidyl ether. Such compounds are also known as surface postcrosslinkers and are described as such in this document.

Further suitable crosslinkers 2 are compounds which can form ionic bonds with at least two carboxylate groups of the polymer particles. Such compounds are also used in surface postcrosslinking as salts of polyvalent cations and are described as such in this document.

Particularly suitable crosslinkers 2 usable in step v) are compounds comprising at least two epoxy groups, for example ethylene glycol diglycidyl ether, diethylene glycol diglycidyl ether, polyethylene glycol diglycidyl ether, propylene glycol diglycidyl ether, polypropylene glycol diglycidyl ether, glycerol polyglycidyl ether, diglycerol polyglycidyl ether and polyglycerol polyglycidyl ether.

The moisture content of the polymer gel obtained in step v) is preferably from 30% to 70% by weight, more preferably from 35% to 65% by weight and most preferably from 40% to 60% by weight, the moisture content being determined analogously to EDANA recommended test method No. WSP 230.2-05 “Mass Loss Upon Heating”.

90% by weight of the undersize removed in step iv) has a particle size of preferably not more than 250 μm, more preferably of not more than 200 μm, most preferably of 150 μm.

The amount of polymer gel 2 recycled into step vi) is preferably from 1% to 50% by weight, more preferably 10% to 40% by weight, most preferably from 20% to 30% by weight, based in each case on the total amount of polymer gel to be dried in step ii).

The crosslinker 2 may be hydrolyzed, especially in the case of compounds comprising at least two epoxy groups. Therefore, the dwell time of the polymer gel 2 between steps v) and ii) should not be too long. The dwell time of polymer gel 2 between steps v) and ii) is therefore preferably not more than 15 minutes, more preferably not more than 10 minutes, most preferably not more than 5 minutes.

The crosslinking reaction of the crosslinker 2 should take place during the drying in step ii). The temperature in the drying operation in step ii) is preferably at least 120° C., more preferably at least 150° C., most preferably at least 170° C. The dwell time in the drying operation in step ii) is preferably at least 10 minutes, more preferably at least 20 minutes, most preferably at least 30 minutes.

It is customary to classify thermally surface post crosslinked polymer particles, with removal of excessively small polymer particles as undersize 2 and recycling of the removed undersize 2 likewise into step v). In this case, the mass of undersize 2 in the total mass of undersize is preferably not more than 10% by weight, more preferably not more than 5% by weight, most preferably not more than 2% by weight.

The process of the invention is preferably performed continuously.

The production of the superabsorbents is described in detail hereinafter:

The superabsorbents are produced by polymerizing a monomer solution or suspension, and are typically water-insoluble.

The monomers a) are preferably water-soluble, i.e. their solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

The monomers a) typically comprise polymerization inhibitors, preferably hydroquinone monoethers, as storage stabilizers.

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 03/104299 A1, WO 03/104300 A1, WO 03/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 02/032962 A2.

The amount of crosslinker b) is preferably 0.05% to 1.5% by weight, more preferably 0.1% to 1% by weight and most preferably 0.3% to 0.6% by weight, calculated in each case on the basis of the total amount of monomer a) used. With rising crosslinker content, the centrifuge retention capacity (CRC) falls and the absorption under a pressure of 21.0 g/cm² (AUL0.3 psi) passes through a maximum.

Initiators c) used may be all compounds which generate free radicals under the polymerization conditions, for example thermal initiators, redox initiators or photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is preferably the disodium salt of 2-hydroxy-2-sulfonatoacetic acid or a mixture of the sodium salt of 2-hydroxy-2-sulfinatoacetic acid, the disodium salt of 2-hydroxy-2-sulfonatoacetic acid and sodium bisulfite. Such mixtures are obtainable as Bruggolite® FF6 and Bruggolite® FF7 (Bruggemann Chemicals; Heilbronn; Germany).

Typically, an aqueous monomer solution is used. The water content of the monomer solution is preferably from 40% to 75% by weight, more preferably from 45% to 70% by weight and most preferably from 50% to 65% by weight. It is also possible to use monomer suspensions, i.e. monomer solutions with monomer a) over and above the solubility, for example sodium acrylate. As the water content rises, the energy expenditure in the subsequent drying rises and, as the water content falls, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors for the polymerization are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on the belt is described, for example, in DE 38 25 366 A1 and U.S. Pat. No. 6,241,928. Polymerization in a belt reactor forms a polymer gel which has to be comminuted, for example in an extruder or kneader.

To improve the drying properties, the comminuted polymer gel obtained by means of a kneader can additionally be extruded.

The acid groups of the resulting polymer gels have typically been partly neutralized. Neutralization is preferably carried out at the monomer stage. This is typically accomplished by mixing in the neutralizing agent as an aqueous solution or else preferably as a solid. The degree of neutralization is preferably from 40 to 85 mol %, more preferably from 50 to 80 mol % and most preferably from 60 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof. Solid carbonates and hydrogencarbonates can also be introduced here in encapsulated form, preferably into the monomer solution directly prior to the polymerization, into the polymer gel during or after the polymerization and prior to the drying thereof. The encapsulation is effected by coating of the surface with an insoluble or only gradually soluble material (for example by means of film-forming polymers, of inert inorganic materials or of fusible organic materials) which delays the dissolution and reaction of the solid carbonate or hydrogencarbonate to such a degree that carbon dioxide is not released until during the drying and the superabsorbent formed has high internal porosity.

The polymer gel is then typically dried with an air circulation belt drier until the residual moisture content is preferably 0.5 to 10% by weight, more preferably 1 to 7% by weight and most preferably 2 to 5% by weight, the residual moisture content being determined by EDANA recommended test method No. WSP 230.2-05 “Mass Loss Upon Heating”. In the case of too high a residual moisture content, the dried polymer gel has too low a glass transition temperature T g and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the polymer gel before the drying is preferably from 25% to 90% by weight, more preferably from 35% to 70% by weight, most preferably from 40% to 60% by weight. Subsequently, the dried polymer gel is crushed and optionally coarsely comminuted.

Thereafter, the dried polymer gel is typically ground and classified, and the apparatus used for grinding may typically be single- or multistage roll mills, preferably two- or three-stage roll mills, pin mills, hammer mills or vibratory mills.

The average particle size of the polymer particles removed as the product fraction is preferably from 150 to 850 μm, more preferably from 250 to 600 μm, very particularly from 300 to 500 μm. The average particle size of the product fraction may be determined by means of EDANA recommended test method No. WSP 220.2 (05) “Particle Size Distribution”, where the proportions by mass of the screen fractions are plotted in cumulative form and the average particle size is determined graphically. The average particle size here is the value of the mesh size which arises for a cumulative 50% by weight.

To further improve the properties, the polymer particles can be thermally surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

The amount of surface postcrosslinker is preferably 0.001% to 2% by weight, more preferably 0.02% to 1% by weight and most preferably 0.05% to 0.2% by weight, based in each case on the polymer particles.

In a preferred embodiment of the present invention, polyvalent cations are applied to the particle surface in addition to the surface postcrosslinkers.

The polyvalent cations usable in the process of the invention are, for example, divalent cations such as the cations of zinc, magnesium, calcium and strontium, trivalent cations such as the cations of aluminum, iron, chromium, rare earths and manganese, tetravalent cations such as the cations of titanium and zirconium. Possible counterions are chloride, bromide, hydroxide, sulfate, hydrogensulfate, carbonate, hydrogencarbonate, nitrate, phosphate, hydrogenphosphate, dihydrogenphosphate and carboxylate, such as acetate and lactate. Aluminum hydroxide, aluminum sulfate and aluminum lactate are preferred.

The amount of polyvalent cation used is, for example, 0.001% to 1.5% by weight, preferably 0.005% to 1% by weight and more preferably 0.02% to 0.8% by weight, based in each case on the polymer.

The surface postcrosslinking is typically performed in such a way that a solution of the surface postcrosslinker is sprayed onto the dried polymer particles. After the spray application, the surface postcrosslinker-coated polymer particles are subjected to thermal treatment.

The spray application of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers have a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The penetration depth of the surface postcrosslinker into the polymer particles can be adjusted via the content of nonaqueous solvent and total amount of solvent.

The thermal treatment is preferably conducted in contact driers, more preferably paddle driers, most preferably disk driers. Suitable driers are, for example, Hosokawa Bepex® Horizontal Paddle Dryer (Hosokawa Micron GmbH; Leingarten; Germany), Hosokawa Bepex® Disk Dryer (Hosokawa Micron GmbH; Leingarten; Germany), Holo-Flite® driers (Metso Minerals Industries Inc.; Danville; USA) and Nara Paddle Dryer (NARA Machinery Europe; Frechen; Germany). Moreover, fluidized bed driers may also be used.

The surface postcrosslinking can be effected in the mixer itself, by heating the jacket or blowing in warm air. Equally suitable is a downstream drier, for example a tray drier, a rotary tube oven or a heatable screw. It is particularly advantageous to effect mixing and thermal surface postcrosslinking in a fluidized bed drier.

Preferred reaction temperatures are in the range of 100 to 250° C., preferably 110 to 220° C., more preferably 120 to 210° C., most preferably 130 to 200° C. The preferred dwell time at this temperature is preferably at least 10 minutes, more preferably at least 20 minutes, most preferably at least 30 minutes, and typically at most 60 minutes.

Subsequently, the surface postcrosslinked polymer particles can be classified again, with excessively small and/or excessively large polymer particles being removed and recycled into the process.

To further improve the properties, the surface postcrosslinked polymer particles can be coated or remoisturized.

The remoisturizing is preferably performed at 30 to 80° C., more preferably at 35 to 70° C., most preferably at 40 to 60° C. At excessively low temperatures the polymer particles tend to form lumps, and at higher temperatures water already evaporates to a noticeable degree. The amount of water used for remoisturizing is preferably from 1% to 10% by weight, more preferably from 2% to 8% by weight and most preferably from 3% to 5% by weight. The remoisturizing increases the mechanical stability of the polymer particles and reduces their tendency to static charging. The remoisturizing is advantageously performed in a cooler after the thermal surface postcrosslinking.

Suitable coatings for improving the swell rate and the gel bed permeability (GBP) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, precipitated silica, such as Sipernat® D17, and surfactants, such as Span® 20.

Methods:

The standard test methods described hereinafter and designated “WSP” are described in: “Standard Test Methods for the Nonwovens Industry”, 2005 edition, published jointly by the Worldwide Strategic Partners EDANA (Herrmann-Debrouxlaan 46, 1160 Oudergem, Belgium, www.edana.org) and INDA (1100 Crescent Green, Suite 115, Cary, North Carolina 27518, USA, www.inda.org). This publication is obtainable both from EDANA and from INDA.

The measurements should, unless stated otherwise, be conducted at an ambient temperature of 23±2° C. and a relative air humidity of 50±10%. The superabsorbent particles are mixed thoroughly before the measurement.

Centrifuge Retention Capacity

Centrifuge retention capacity (CRC) is determined by EDANA recommended test method No. WSP 241.2 (05) “Fluid Retention Capacity in Saline, After Centrifugation”.

Absorption Under a Pressure of 21.0 g/Cm² (Absorption Under Load)

Absorption under a pressure of 21.0 g/cm² (AUL) is determined by EDANA recommended test method No. WSP 242.2 (05) “Absorption Under Pressure, Gravimetric Determination”.

Absorption Under a Pressure of 49.2 g/Cm² (Absorption Under High Load)

Absorption under a pressure of 49.2 g/cm² (AUHL) is determined analogously to EDANA recommended test method No. WSP 242.2 (05) “Absorption Under Pressure, Gravimetric Determination”, except that a pressure of 49.2 g/cm² (0.7 psi) is established rather than a pressure of 21.0 g/cm² (0.3 psi).

Vortex Test

50.0 ml±1.0 ml of a 0.9% by weight aqueous sodium chloride solution are introduced into a 100 ml beaker which comprises a magnetic stirrer bar of size 30 mm×6 mm. A magnetic stirrer is used to stir the sodium chloride solution at 600±10 rpm. Then 2.000 g±0.010 g of superabsorbent particles is added as rapidly as possible, and the time taken for the stirrer vortex to disappear as a result of the absorption of the sodium chloride solution by the superabsorbent particles is measured. When measuring this time, the entire contents of the beaker may still be rotating as a homogeneous gel mass, but the surface of the gelated sodium chloride solution must no longer exhibit any individual turbulences. The time required is reported as the vortex. For one sample, the average from two measurements is sufficient if the measurements differ from one another by not more than 5%.

### EXAMPLES

### Examples 1 to 4

Production of the Superabsorbent Particles:

By continuously mixing deionized water, 50% by weight sodium hydroxide solution and acrylic acid, an acrylic acid/sodium acrylate solution was prepared such that the degree of neutralization corresponded to 72.0 mol %. The solids content of the monomer solution was 42.5% by weight.

The crosslinker 1 used was 3-tuply ethoxylated glyceryl triacrylate (purity about 85% by weight). The amount used was 1.2 kg per t of monomer solution.

The free-radical polymerization was initiated using, per t of monomer solution, 1.39 kg of a 0.25% by weight aqueous hydrogen peroxide solution, 3.58 kg of a 15% by weight aqueous sodium peroxodisulfate solution and 1.28 kg of a 1% by weight aqueous ascorbic acid solution.

The throughput of the monomer solution was 20 t/h. The reaction solution had a feed temperature of 23.5° C.

The individual components were metered in the following amounts continuously into a List Contikneter continuous kneader reactor with a capacity of 6.3 m 3 (LIST AG, Arisdorf, Switzerland):

| | | |
|---|---|---|
| 20 | t/h | of monomer solution |
| 24 | kg/h | of 3-fold ethoxylated glycerol triacrylate (about |
| | | 85% by weight) |
| 99.4 | kg/h | of hydrogen peroxide solution/sodium peroxodisulfate |
| | | solution |
| 25.6 | kg/h | of ascorbic acid solution |

Between the addition point for the crosslinker and the addition sites for the initiators, the monomer solution was inertized with nitrogen.

After about 50% of the dwell time there was an additional metered addition to the reactor of polymer particles that were obtained from the production process by comminution and classification and have a particle size of less than 150 μm (1000 kg/h). The dwell time of the reaction mixture in the reactor was 15 minutes.

The resultant polymer gel (polymer gel A) obtained was applied to the conveyor belt of an air circulation belt drier by means of an oscillating conveyor belt. The air circulation belt drier had a length of 48 m. The conveyor belt of the air circulation belt drier had an effective width of 4.4 m. On the air circulation belt drier, an air/gas mixture (about 175° C.) flowed continuously around the aqueous polymer gel and dried it. The dwell time in the air circulation belt drier was 37 minutes.

The dried polymer gel was comminuted by means of a three-stage roll mill and sieved off to a particle size of 150 to 850 μm. Polymer particles having a particle size of less than 150 μm were separated off (polymer particles B). Polymer particles having a particle size of greater than 850 μm were recycled into the comminution. Polymer particles having a particle size in the range from 150 to 850 μm (polymer particles A) were thermally surface postcrosslinked.

The polymer particles were coated with a surface postcrosslinker solution in a Schugi Flexomix® (Hosokawa Micron B.V., Doetinchem, the Netherlands) and then dried in a NARA Paddle Dryer (GMF Gouda, Waddinxveen, the Netherlands) at 176° C. for 45 minutes.

The following amounts were metered into the Schugi Flexomix®:

| | | |
|---|---|---|
| 7.5 | t/h | of polymer particles |
| 348.75 | kg/h | of surface postcrosslinker solution |

The surface postcrosslinker solution comprised 2.2% by weight of 2-hydroxyethyl-2-oxazolidone, 2.2% by weight of propane-1,3-diol, 29.0% by weight of propane-1,2-diol, 3.2% by weight of aluminum sulfate, 56.9% by weight of water and 6.5% by weight of isopropanol.

After drying, the surface postcrosslinked polymer particles were cooled down to about 60° C. in a NARA Paddle-Cooler (GMF Gouda, Waddinxveen, the Netherlands). At the same time, the surface post crosslinked polymer particles were coated with 124.5 kg of a 2.4% by weight aqueous polyethylene glycol solution (polyethylene glycol having an average molar mass of 400 g/mol).

Agglomeration of the removed under size:

207.0 g of water was added to 180.0 g of polymer particles B, which were ground in an X70 meat grinder (Scharfen Slicing Machines GmbH, Witten, Germany). The resultant polymer gel was transferred to a polyethylene tank, sprayed with a mixture of 0.18 g of ethylene glycol diglycidyl ether (crosslinker 2) and 13.0 g of water, and ground twice in the meat grinder.

The polymer gel thus obtained (polymer gel B) was immediately dried together with polymer gel A in an air circulation drying cabinet at 170° C. for 60 minutes. For this purpose, polymer gel A was distributed on a drying tray and then polymer gel B was added. A total of 700 g of polymer gel was dried.

The dried polymer gel was comminuted by means of a roll mill and sieved off to a particle size of 300 to 600 μm. Subsequently, the polymer particles were thermally surface postcrosslinked. For this purpose, the polymer particles were sprayed in a food processor with a mixture of 0.088 g of 2-hydroxyethyl-2 oxazolidone, 0.088 g of propane-1,3-diol, 1.8 g of propane-1,2-diol, 0.88 g of a 26.8% by weight aqueous aluminum sulfate solution and 3.5 g of water, and stirred for one minute.

This was followed by drying at 180° C. for 40 minutes and sieving off again to a particle size of 300 to 600 μm. The resultant superabsorbent particles were analyzed.

TABLE 1
Mixing with preswelling

| | Proportion | Proportion | | | | |
|---|---|---|---|---|---|---|
| | of polymer | of polymer | CRC | AUL | AUHL | Vortex |
| Example | gel A | gel B | [g/g] | [g/g] | [g/g] | [s] |
| 1*) | 100% | 0% | 29.5 | 28.8 | 22.7 | 75 |
| 2 | 95% | 5% | 28.9 | 28.4 | 22.7 | 73 |
| 3 | 90% | 10% | 28.5 | 27.9 | 22.5 | 72 |
| 4 | 85% | 15% | 27.8 | 27.6 | 22.2 | 69 |

*)comparative example

The examples show a distinct improvement in absorption rate (vortex) with increasing proportion of polymer gel B.

### Examples 5 to 8

The procedure was as in examples 1 to 4, except that polymer gel B was produced by spraying 180.0 g of polymer particles B with a mixture of 0.18 g of ethylene glycol diglycidyl ether (crosslinker 2) and 220.0 g of water, and grinding three times with the meat grinder.

TABLE 2
Experimental results

| | Proportion | Proportion | | | | |
|---|---|---|---|---|---|---|
| | of polymer | of polymer | CRC | AUL | AUHL | Vortex |
| Example | gel A | gel B | [g/g] | [g/g] | [g/g] | [s] |
| 5*) | 100% | 0% | 30.7 | 29.6 | 23.3 | 74 |
| 6 | 95% | 5% | 29.0 | 28.0 | 21.1 | 79 |
| 7 | 90% | 10% | 30.0 | 25.8 | 21.3 | 73 |
| 8 | 85% | 15% | 29.9 | 26.7 | 22.2 | 70 |

*)comparative example

The examples show an improvement in absorption rate (vortex) with increasing proportion of polymer gel B.

### Examples 9 to 12

The procedure was as in examples 1 to 4, except that polymer gel A and polymer gel B were ground twice together in the meat grinder.

TABLE 3
Experimental results

| | Proportion | Proportion | | | | |
|---|---|---|---|---|---|---|
| | of polymer | of polymer | CRC | AUL | AUHL | Vortex |
| Example | gel A | gel B | [g/g] | [g/g] | [g/g] | [s] |
| 9*) | 100% | 0% | 27.0 | 25.0 | 19.1 | 51 |
| 10*) | 95% | 5% | 27.0 | 24.4 | 18.8 | 51 |
| 11*) | 90% | 10% | 27.4 | 25.7 | 19.6 | 50 |
| 12*) | 85% | 15% | 26.9 | 25.6 | 19.9 | 50 |

*)comparative example

The examples overall show a distinct drop in centrifuge retention capacity (CRC), absorption under a pressure of 49.2 g/cm² (AUHL) and absorption under a pressure of 21.0 g/cm² (AUL). The cause of this is probably the additional extrusion of polymer gel A in examples 9 to 12.

1. A process for producing surface postcrosslinked superabsorbent particles by polymerizing a monomer solution or suspension comprising
a) at least one ethylenically unsaturated monomer which bears an acid group and is at least partly neutralized,
b) at least one crosslinker 1, and
c) at least one initiator,
comprising
i) polymerizing the monomer solution or suspension and optionally extruding the resultant polymer gel 1,
ii) drying the polymer gel 1,
iii) comminuting the dried polymer gel 1,
iv) classifying the polymer particles obtained in step iii), with removal of excessively small polymer particles as undersize 1 and optionally with recycling of excessively large particles into step iii), and with thermal surface postcrosslinking of the remaining polymer particles in a further step,
v) mixing the removed undersize 1 with an aqueous solution and optionally extruding a resultant polymer gel 2, and
vi) recycling the polymer gel 2 into step ii),
wherein the polymer gel is statically dried in step ii), the moisture content of the polymer gel 2 obtained in step v) is from 20% to 80% by weight, the aqueous solution in step v) comprises at least one crosslinker 2, and the crosslinker 2 can form covalent or ionic bonds with at least two carboxylate groups of the polymer particles.

2. The process according to claim 1, wherein, in step v), the removed undersize 1 is first mixed with water and/or an aqueous base and optionally extruded and then mixed with the aqueous solution and optionally extruded.

3. The process according to claim 1, wherein the aqueous solution in step v) comprises from 0.01% to 1.0% by weight of the at least one crosslinker 2, based on the amount of removed undersize.

4. The process according to claim 1, wherein aqueous solution in step v) comprises from 0.05% to 0.2% by weight of the at least one crosslinker 2, based on the amount of removed undersize.

5. The process according to claim 1, wherein the at least one crosslinker 2 used in step v) can form covalent bonds with at least two carboxylate groups of the polymer particles.

6. The process according to claim 5, wherein the at least one crosslinker 2 used in step v) comprises at least two epoxy groups.

7. The process according to claim 1, wherein a moisture content of the polymer gel obtained in step v) is from 40% to 60% by weight.

8. The process according to claim 1, wherein 90% by weight of the undersize 1 removed in step iv) has a particle size not exceeding 250 μm.

9. The process according to claim 1, wherein 90% by weight of the undersize 1 removed in step iv) has a particle size not exceeding 150 μm.

10. The process according to claim 1, wherein an amount of polymer gel recycled into step vi) is from 1% to 50% by weight, based on the total amount of polymer gel to be dried in step ii).

11. The process according to claim 1, wherein an amount of polymer gel recycled into step vi) is from 20% to 30% by weight, based on the total amount of polymer gel to be dried in step ii).

12. The process according to claim 1, wherein a dwell time of the polymer gel 2 between steps v) and ii) is not more than 5 minutes.

13. The process according to claim 1, wherein a temperature in the drying operation in step ii) is at least 120° C.

14. The process according to claim 1, wherein a dwell time in the drying operation in step ii) is at least 10 minutes.

15. The process according to claim 1, wherein the surface postcrosslinked polymer particles are classified, with removal of excessively small polymer particles as the undersize 2, recycling of the removed undersize 2 into step v), where a mass of the undersize 2 in a total mass of undersize is not more than 10% by weight.
